(19) United States
(12) Patent Application Publication
(10) Pub. No.: US 2024/0126914 A1
(43) Pub. Date: Apr. 18, 2024

(54) METHOD, APPARATUS AND ELECTRONIC DEVICE FOR DATA PROCESSING

(71) Applicant: Beijing Zitiao Network Technology Co., Ltd., Beijing (CN)

(72) Inventors: Shiqi Wan, Beijing (CN); Zhenjia Wang, Beijing (CN)

(21) Appl. No.: 18/396,066

(22) Filed: Dec. 26, 2023

Related U.S. Application Data
(63) Continuation of application No. PCT/CN2022/123809, filed on Oct. 8, 2022.

(30) Foreign Application Priority Data
Oct. 9, 2021 (CN) 202111179345.4

(51) Int. Cl. G06F 21/62; G06F 16/22; G06F 16/2458; G06F 16/27

(52) U.S. Cl. CPC G06F 21/6227; G06F 16/2282; G06F 16/2468; G06F 16/275

(57) ABSTRACT

Embodiments of the disclosure disclose a method, apparatus and electronic device for data processing. The method includes: obtaining a first data table and a second data table; and determining an associated field in the first data table, and establishing a bidirectional association relationship between the first data table and the second data table through the associated field, wherein a target permission for using the first data table is set for a target user in the establishment of the bidirectional association relationship, the target user being a user associated with the second data table.

### CROSS REFERENCE

The application is a continuation of International Patent Application No. PCT/CN2022/123809, filed on Oct. 8, 2022, which claims the benefit of Chinese Patent Application No. 202111179345.4 filed on Oct. 9, 2021 and entitled “Method, Apparatus and Electronic Device for Data Processing”, the content of which is incorporated herein by reference in its entirety.

### FIELD

The present disclosure relates to the field of data processing, in particular to a method, an apparatus and an electronic device for data processing.

### BACKGROUND

Generally, data information may be stored in a data table. In order to store large-scale data in data tables, data tables have been developed from two-dimensional data tables to multidimensional data tables.

Multidimensional data tables are similar to lightweight databases, and users can store all kinds of data in a multidimensional data table.

### SUMMARY

The Summary of the present disclosure is provided to present the ideas briefly, which will be described in detail later in Detailed Description. This Summary of the present disclosure is not intended to identify the key or necessary features of the technical solution to be protected, nor is it intended to limit the protection scope of the technical solution.

Embodiments of the present disclosure provide a method, apparatus and electronic device for data processing.

In a first aspect, embodiments of the present disclosure provide a method for data processing, which comprises: obtaining a first data table and a second data table; and determining an associated field in the first data table, and establishing a bidirectional association relationship between the first data table and the second data table through the associated field, wherein an associated field is determined in the first data table, and a bidirectional association relationship between the first data table and the second data table is established through the associated field, wherein a target permission for using the first data table is set for a target user in the establishment of the bidirectional association relationship, the target user being a user associated with the second data table.

In a second aspect, embodiments of the present disclosure provide an apparatus for data processing device, which comprises: an obtaining unit configured to obtain a first data table and a second data table; and an association relationship establishment unit configured to determine an associated field in the first data table, and establish a bidirectional association relationship between the first data table and the second data table through the associated field, wherein an associated field is determined in the first data table, and a bidirectional association relationship between the first data table and the second data table is established through the associated field, wherein a target permission for using the first data table is set for a target user in the establishment of the bidirectional association relationship, the target user being a user associated with the second data table.

In a third aspect, embodiments of the present disclosure provide one or more processors; and a storage device for storing one or more programs. The one or more programs, when executed by one or more processors, cause the one or more processors to implement a method for data processing in the first aspect.

In a fourth aspect, embodiments of the present disclosure provide a computer-readable medium having a computer program stored thereon. The program, when executed by the processor, implements steps of the method for data processing in the first aspect.

The methods, apparatuses and electronic devices for data processing provided by embodiments of the present disclosure are obtained by obtaining a first data table and a second data table; and determining an associated field in the first data table, and establishing a bidirectional association relationship between the first data table and the second data table through the associated field, wherein a target permission for using the first data table is set for a target user in the establishment of the bidirectional association relationship, the target user being a user associated with the second data table.

### BRIEF DESCRIPTION OF THE DRAWINGS

In conjunction with the drawings and with reference to the following specific embodiments, the above and other features, advantages and aspects of the embodiments of the present disclosure will become more apparent. Throughout the drawings, identical or similar drawings marks indicate identical or similar elements. It should be understood that the drawings are schematic and that the originals and elements are not necessarily drawn to scale.

FIG. 1 is a flow chart of one embodiment of a method for data processing according to the present disclosure;

FIG. 2 is a flow chart of another embodiment of the method for data processing according to the present disclosure;

FIG. 3 is a schematic structural diagram of an embodiment of a data processing device according to the present disclosure;

FIG. 4 is an exemplary system architecture to which a method for data processing of an embodiment of the present disclosure can be applied; and

FIG. 5 is a schematic diagram of a basic structure of an electronic device provided in accordance with embodiments of the present disclosure.

### DETAILED DESCRIPTION

Embodiments of the present disclosure will be described in greater detail below with reference to the accompanying drawings. Although certain embodiments of the present disclosure are shown in the accompanying drawings, it should be understood, however, that the present disclosure may be realized in various forms and should not be construed as being limited to the embodiments set forth herein, but rather are provided for a more thorough and complete understanding of the present disclosure. It should be understood that the accompanying drawings and embodiments of the present disclosure are for exemplary purposes only and are not intended to limit the scope of protection of the present disclosure.

It should be understood that the various steps documented in the method embodiments of the present disclosure may be performed in a different order, and/or in parallel. Furthermore, the method embodiments may include additional steps and/or omit performing the illustrated steps. The scope of the present disclosure is not limited in this regard.

The term “including” and variations thereof, as used herein, is open-ended, i.e., “including but not limited to.” The term “based on” is “based at least in part on.” The term “one embodiment” means “at least one embodiment”; the term “another embodiment” means “at least one additional embodiment”; the term “another embodiment” means “at least one other embodiment.”; and the term “some embodiments” means “at least some embodiments”. Related definitions of other terms will be given in the following description.

It is to be understood that the concepts of “first”, “second” and the like mentioned in the present disclosure are only used to differentiate different devices, modules or units, and are not used to define the order or interdependence of the functions performed by these devices, modules or units.

It is to be understood that the modifications of “one” and “a plurality of” mentioned in the present disclosure are schematic rather than limiting, and the person skilled in the art should understand that, unless otherwise expressly stated in the context, they should be understood as “one or more”.

The names of the messages or information interacting between the plurality of apparatuses of the present disclosure are for illustrative purposes only and are not intended to limit the scope of those messages or information.

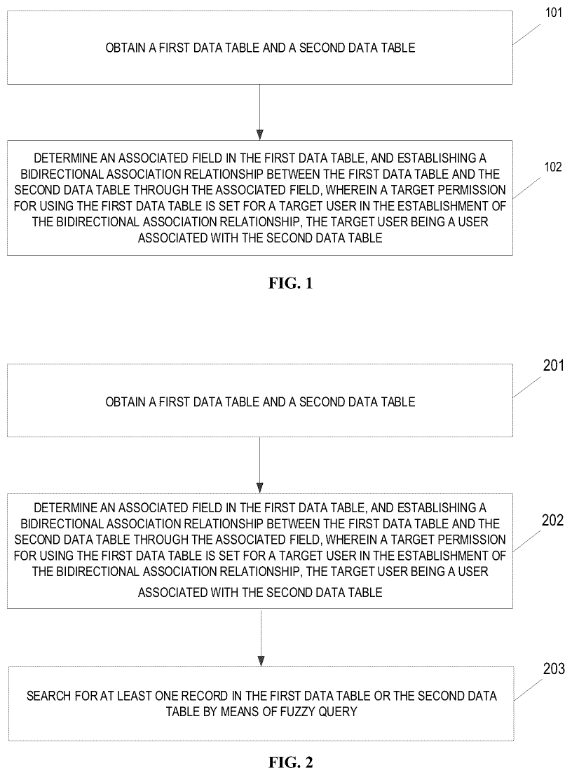

Referring to FIG. 1, which illustrates a flow chart of one embodiment of a method for data processing according to the embodiments of the present disclosure. The method for data processing as shown in FIG. 1 includes the following steps.

Step 101, obtaining a first data table and a second data table.

The first data table here may be a multidimensional data table or a two-dimensional data table. The second data table may be a multidimensional data table or a two-dimensional data table.

The first data table may have multiple data recorded in advance, or it may be a blank data table.

The first data table and the second data table may record different contents. For example, the first data table is the student table and the second data table is the course schedule.

In some application scenarios, the first data table and the second data table may be the same data table. In addition, the first data table and the second data table may be different data tables.

Step 102, determining an associated field in the first data table, and establishing a bidirectional association relationship between the first data table and the second data table through the associated field. In the establishment of the bidirectional association relationship, a target permission for using the first data table is set for a target user, and the target user is a user associated with the second data table.

The first data table may include a plurality of fields. In a two-dimensional data table, a field of the above fields may correspond to a column of a table in which the in which the field is located. In a multidimensional data table, this field may correspond to at least a plurality of cells formed by the column in which the field is located and a plurality of rows. Here, a cell refers to the smallest unit in the data table.

In some application scenarios, it is possible to enter an associated field in the first data table. In other application scenarios, an existing field in the first data table may be selected as the associated field. The associated field may be recorded in any cell.

A preset association operation may be performed on the associated field to establish a bidirectional association relationship between the associated field and the second data table, and to establish a bidirectional association between the first data table and the second data table.

The first data table may correspond to the first user, and the second data table may correspond to the second user. The first and second users may be different users. The first data table may be, for example, an e-commerce order data table. An e-commerce data table may include a plurality of items. Different items may come from different suppliers. The second data table may be a data table corresponding to a supplier of a good, such as a data table of stock of goods of that supplier. The first user here may be the e-commerce platform. The second user may be the supplier mentioned above.

When establishing a bidirectional association relationship between the first data table and the second data table, the target permissions of the users of the second data table to use the data of the first data table may be set in various ways.

The above target permissions may include one of the following: the first data table being invisible, the first data table being visible but non-editable, the associated field being non-editable, a target row being invisible, the target row is visible but non-editable, a target column being invisible, or the target column being visible but non-editable.

The first data table above being invisible means that the second user does not have permission to browse the data in the first data table. The first data table being visible and non-editable means that the second user has the permission to browse the data in the first data table, but the second user has no permission to edit the data in the first data table. The associated field is non-editable means that the second user has the permission to browse the associated field, but does not have the permission to edit the associated field. The target row being invisible means that the second user has no permission to browse the data of a target row. The target row being visible but non-editable means that the second user has the permission to browse the data of the target row, but does not have the permission to edit the data of the target row. The target row being invisible means that the second user does not have permission to browse the data in the target row. The target column being visible but non-editable means that the second user has the permission to browse the data in the target column, but does not have the permission to edit the data in the target column.

In some optional implementations, in the establishment of the bidirectional association relationship described above, setting a target permission for the target user associated with the second data table to use the first data table includes the following steps.

First, in response to the establishment of the bidirectional association relationship being trigged by the user, displaying a permission setting item.

The above permission setting items may include, but are not limited to, the first data table being invisible, the first data table being visible but non-editable, the associated field being non-editable, a target row being invisible, the target row is visible but non-editable, a target column being invisible, and the target column being visible but non-editable.

Second, determining the target permission based on a selection operation of the user for the permission setting item.

After the user selects the target permission, a bidirectional association relationship between the first data table and the second data table may be established through subsequent related operations, and the above bidirectional association relationship defines a target permission for the target user to use the first data table.

After setting the target permission for the target user to use the first data table, the target user may only use the first data table based on the above target permission. In addition to the above target permissions, the target user cannot perform other operations for the first data table.

In other application scenarios, in the establishment of a bidirectional association relationship, the first user of the first data table may also use a using permission of the second data table. The use of the second data table by the first user cannot exceed the using permission of the second data table.

In practice, a predetermined operation may be performed on the associated fields of the first data table, such as cursor selection, right clicking, and so on. According to the predetermined operation, a selection item used to indicate the establishment of a bidirectional connection with other data tables may be displayed. After the selection time of the bidirectional connection is triggered, a candidate data table to be connected may be provided. The data table to be connected includes the second data table mentioned above. The user may select the second data table, and after the second data table is selected, the above permission setting item may be displayed.

According to the method for data processing provided in this embodiment, the first data table and the second data table are obtained; the associated field is determined in the first data table and a bidirectional association relationship between the first data table and the second data table is established through the associated field. In the establishment of the bidirectional association relationship, a target permission is set for the target user associated with the second data table to use the first data table, so that the user of the second data table can only perform the using operation for the first data table corresponding to the target permission. This can avoid the information leakage of the data table and improve the security of the data table.

In some optional implementations of this embodiment, the method for data processing also includes: creating a matching field corresponding to the associated field in the second data table.

After establishing a bidirectional association with the second data table, the matching field may be created automatically in the second data table.

Further, an identification of the matching field may include at least a part of an identification of the associated field.

The identification of the above matching field may, for example, be identical to the identification of the associated field, or may include at least a part of the identification of the associated field. For example, if the identification of the associated field is “Student,” then the identification of the created matching field may also be “Student.” For example, if the identification of the associated field is “Student” and if the identification of the second data table is “Data Table 2”, then the identification of created matching field may be “Student-Data Table 2”.

In this way, the matching field of the second data table includes information of the associated field of the first data table, which may help the user quickly identify the related fields of the two data tables and facilitate the user to search.

In further application scenarios, the above method for data processing also include: if there is no view locking for the first data table, displaying a data view of the second data table based on a trigger operation of the user for the associated field.

In the state of view locking, no one (including the table owner and the person locking the view) can modify the view's field visibility, apply filters, group, sort, adjust row heights, or delete the view. In the state of view locking, collaborators with editing rights can still modify and delete table contents.

Here, “there is no view locking” means that the view locking is absent for the first data table.

Further, if there is no view locking for the first data table, displaying a data view of the second data table includes: if there is no view locking for the first data table, displaying complete table data of the second data table.

In these optional implementations, the above second data table may currently display a data view, also known as a Grid View. In these optional implementations, based on the user's triggered action for the associated field, the complete table data of the second data table may be displayed, also known as Grid View.

In some further optional implementations, the above second data table currently displays a graph generated based on the data recorded in the second data table. In these optional implementations, a graph corresponding to the data in the second data table may be displayed based on a trigger operation of the user for the associated field.

In some optional implementations, the above method for data processing further includes: in response to updating of data corresponding to the associated field in the first data table, updating synchronously in the second data table; or in response to updating of data corresponding to a matching field in the second data table, updating synchronously in the first data table.

In these optional implementations, the above data updating includes data addition, deletion, and modification. If either of the associated field of the first data table or the matching field of the second data table is updated, the other is updated accordingly.

In these optional implementations, the two data tables may be updated synchronously in either of the first and second data tables by means of bidirectional synchronization updating as described above. For example, in the first data table, the associated field “Student” is added with the data of student “A”, and correspondingly, the data of student “A” is added to the data corresponding to the matching field.

The following takes the first data table as the student table (Table 1) and the second data table as the course schedule (Table 2) for example.

TABLE 1

| | Student | |
|---|---|---|
| Students | number | Courses |
| Xiao Wang | X1 | Chinese, Biology, Physics, Mathematics |
| Xiao Zhou | X2 | English, Chinese, Physics |
| Xiao Liu | X3 | Mathematics, Biology |

TABLE 2

| Lessons | Course number | Student |
|---|---|---|
| Chinese | Y1 | Xiao Wang, Xiao Zhou |
| Mathematics | Y2 | Xiao Liu |
| English | Y3 | Xiao Zhou |
| Biology | Y4 | Xiao Wang, Xiao Liu |
| Physics | Y5 | Xiao Wang, Xiao Zhou |

The “Student” field in Table 1 may be an associated field, and the “Student” field in Table 2 may be a matching field. The “Student” field in Table 2 may be automatically created in Table 2 when a bidirectional association with Table 2 is performed on the associated field in Table 1. In addition, when the course information corresponding to each student is filled in the student column in Table 1, the information of each student “student” may be filled in the student column corresponding to Table 2. When a student “Xiao Liu” is added into the “Student” field of Table 1, and “Mathematics” and “Biology” are filled in the corresponding course of “Xiao Liu”, the data of Xiao Liu is added into the “student” field of Table 2. Specifically, the cells of corresponding courses of Xiao Liu, “Mathematics” and “Biology”, are filled with the “Xiao Liu”.

In addition, if Xiao Wang is deleted from the “student” corresponding to “Physics” in Table 2, “Xiao Wang” is also deleted from the course “Physics” section in Table 1.

In some application scenarios, the associated fields in the first data table correspond to the matching fields in the second data table. The above method for data processing may further include: when deleting an associated field, displaying the first deletion prompt message, the first delete indication information being used to indicate that the associated field is associated with the matching field, and indicate that the association relationship therebetween is to be removed first; or, when deleting the matching field, displaying the second deletion prompt information, the second delete indication message being used to indicate that the matching field is associated with the associated field, and indicate remove the association relationship therebetween is to be removed first.

In other words, when deleting an associated field or a matching field that has established a bidirectional association relationship, it is necessary to indicate to delete the bidirectional association relationship first, and then delete the associated field or delete the matching field. That is, the bidirectional association relationship between the first data table and the second data table needs to be deleted first, and then it is allowed to delete the associated field or delete the matching field.

In further optional implementations, the method for data processing further includes setting a range of records of the second data table bidirectionally associated with the first data table in a state where the associated field is selected.

The setting of a range of records of the second data table bidirectionally associated with the first data table may be performed by selecting a plurality of rows of records in the second data table. Alternatively, this may be performed by selecting records corresponding to a plurality of cells.

In this way, the associated field may be bidirectional associated with a plurality of records in the second data table.

In some optional implementations, the setting a range of records of the second data table bidirectionally associated with the first data table in a state where the associated field is selected includes: in response to a presetting operation of the user for the associated field, displaying a filtering criteria entry; and determining the range of records of the associated field that is bidirectionally associated with the second data table based on a filtering criteria set by the user at the filtering criteria entry.

Filtering criteria may be entered through the above filtering criteria entry. The above filtering criteria may include words and/or numbers. For example, the first data table is the e-commerce data table and the second data table is the corresponding data table of a men's clothing supplier. The above filtering criteria may include style and size. The filtering criteria may be used to quickly determine, from the second data table, the range of records corresponding to the screening criteria.

In these alternative implementations, the range of records associated with the first data table may be quickly determined from the second data table by entering the filtering criteria as described above.

In some optional implementations, the step 102 includes: selecting, in the second data table, at least two records that are bidirectionally associated with the associated field in the first data table.

That is, in these optional implementations, it is possible to select more than two records from the second data table to achieve a bidirectional association with the associated field in the first data table.

Specifically, a multi-record association option may be provided when establishing a bidirectional association between an associated field and a second data table. When the user selects the above multi-record association option, the user may select a plurality of records from the second data table for bidirectional association with the associated field.

Further, a single record association option may further be provided. When a user selects the single record association option, a single record selected by the user from the second data table may be bidirectional associated with the associated field.

In these optional implementations, one or more records that are associated with the associated field in the second data table may be determined through the multiple record association option or the single record association option.

Further optionally, the above method for data processing also includes: maintaining, based on a change operation performed by the user that changes a multi-record association to a single record association, a multi-record association established before the change operation, and after the change operation, bidirectionally associating, based on a selection operation of the user for the single record, the selected single record and the associated field.

That is, when the change operation is performed, the association of a plurality of records established before the change operation may be kept unchanged. After the change operation, the bidirectional association of a single record and the associated field may be performed.

Through the above association selection, the user may selected one of the multi-record association option and the single record association option, which facilitates the user to control the record of the association records.

Reference is made to FIG. 2, which shows the flow of another embodiment of the method for data processing according to the present disclosure. The method for data processing, as shown in FIG. 2, comprises the following steps.

Step 201, obtaining a first data table and a second data table.

Step 202, determining an associated field in the first data table, and establishing a bidirectional association relationship between the first data table and the second data table through the associated field, whereby a target permission for using the first data table is set for a target user in the establishment of the bidirectional association relationship, the target user being a user associated with the second data table.

The implementations of the above steps 201 and 202 may be referred to the steps 101 and 102 of the embodiments shown in FIG. 1, which are not detailed here.

In step 203, searching for at least one record in the first data table or the second data table by means of fuzzy query.

After establishing the bidirectional association between the first data table or the second data table, at least one record may be found in the first data table or the second data table by means of fuzzy query. The record here may be a record corresponding to the associated field.

The fuzzy query mentioned above may refer to that it is possible that the entered query keywords are not very precise.

In some optional implementations, the above searching for at least one record by means of fuzzy query includes: searching for a record matching each of at least one keyword based on the at least one keyword inputted by means of fuzzy query.

The keywords may be spaced by other symbols, such as a Space and so on.

Each keyword may correspond to a field in the second data table. Each keyword in at least one of the above keywords may correspond to a different field.

A record matching each of the above keywords may be searched for in records corresponding to the associated field in the first data table and in the second data table.

When searching, as long as the record contains keywords, it may be found out. For example, if searching “shoe 37”, since “shoe” and “37” are different fields, it can be found out through the space query.

In these optional implementations, the search of the record does not need to use the exact search keywords, you may use the fuzzy search method in the first data table or the second data table to find the record that matches the above keywords.

In some alternative implementations, the method for data processing further includes converting the bidirectional association relationship to a unidirectional association relationship based on a received conversion operation for the association relationship.

Through the conversion of the association relationship, the bidirectional association relationship is converted to be a unidirectional association relationship, or the unidirectional association relationship is converted to be a bidirectional association relationship, so as to achieve the control of the usage of data.

Compared with the embodiment shown in FIG. 1, the method for data processing provided in this embodiment highlights the steps of searching records in the first data table or the second data table by means of fuzzy query, which facilitates the user to search for relevant records.

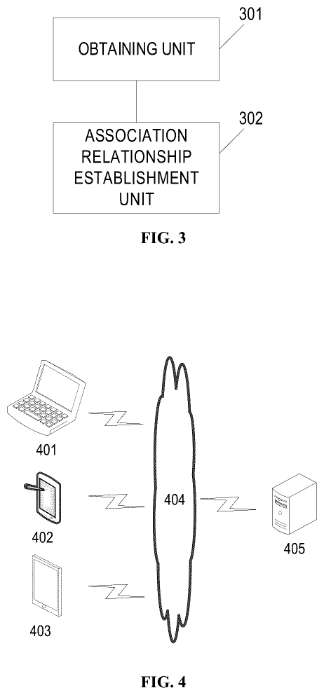

With further reference to FIG. 3, as an implementation of the methods shown in the above figures, the present disclosure provides an embodiment of an apparatus for data processing, which corresponds to the embodiment of the method shown in FIG. 1. The apparatus may be specifically applied to various electronic devices.

As shown in FIG. 3, the data processing device of the embodiments of the present disclosure comprises: an obtaining unit 301 configured to obtain a first data table and a second data table; and an establishment unit 302 configured to determine an associated field in the first data table, and establish a bidirectional association relationship between the first data table and the second data table through the associated field, wherein a target permission for using the first data table is set for a target user in the establishment of the bidirectional association relationship, the target user being a user associated with the second data table.

In the embodiments of the present disclosure, the obtaining unit 301 and the establishment unit 302 of the data processing device may be discussed with reference to relevant descriptions of steps 101 and 102 in the corresponding embodiment in FIG. 1, respectively, which will not be repeated here.

In some optional implementations, the target permissions include one of the following: the first data table being invisible, the first data table being visible but non-editable, the associated field being non-editable, a target row being invisible, the target row is visible but non-editable, a target column being invisible, the target column being visible but non-editable.

In some optional implementations, the establishment unit 302 is further configured to: in response to the establishment of the bidirectional association relationship being trigged by the user, display a permission setting item; and determine the target permission based on a selection operation of the user for the permission setting item.

In some optional implementations, the establishment unit 302 is further configured to create a matching field corresponding to the associated field in the second data table.

In some optional implementations, an identification of the matching field comprises at least a part of an identification of the associated field.

In some optional implementations, the apparatus for data processing also includes a display unit (not shown) that is configured to: if a view of the first data table is not locked, display a data view of the second data table based on a trigger operation of the user for the associated field.

In some optional implementations, the display unit is further configured to: if the view of the first data table is not locked, display complete table data of the second data table.

In some optional implementations, the display unit is further configured to: if the view of the first data table is not locked, display a chart corresponding to data in the second data table based on a selection of the user.

In some alternative implementations, the apparatus for data processing further includes a synchronization unit (not shown), which is configured to: in response to updating of data corresponding to the associated field in the first data table, update synchronously in the second data table; or in response to updating of data corresponding to a matching field in the second data table, update synchronously in the first data table.

In some optional implementations, the apparatus for data processing further includes a setting unit (not shown) that is configured to: set a range of records of the second data table bidirectionally associated with the first data table in a state where the associated field is selected.

In some optional implementations, the setting unit is further configured to: in response to a presetting operation of the user for the associated field, display a filtering criteria entry; and determine the range of records of the associated field that is bidirectionally associated with the second data table based on a filtering criteria set by the user at the filtering criteria entry.

In some optional implementations, the setting unit 302 is further configured to: select, in the second data table, at least two records that are bidirectionally associated with the associated field in the first data table.

In some optional implementations, the apparatus for data processing further includes a first change unit (not shown), which is configured to: maintain, based on a change operation performed by the user that changes a multi-record association to a single record association, a multi-record association established before the change operation, and after the change operation, bidirectionally associate, based on a selection operation of the user for the single record, the selected single record and the associated field.

In some optional implementations, the apparatus for data processing further includes a query unit (not shown), which is configured to: search for at least one record in the first data table or the second data table by means of fuzzy query.

In some optional implementations, the query unit is further configured to: search for a record matching each one of at least one keyword based on the at least one keyword inputted by means of fuzzy query.

In some optional implementation methods, the associated field corresponds to the matching field, the apparatus for data processing further includes a deletion unit (not shown), the deletion unit is configured to: in response to receiving an instruction for deleting the associated field, displaying first delete indication information, the first delete indication information being used to indicate that the associated field is associated with the matching field, and indicate that the association relationship therebetween is to be removed first; or, in response to receiving an instruction for deleting the matching field, displaying a second delete indication message, the second delete indication message being used to indicate that the matching field is associated with the associated field, and indicate remove the association relationship therebetween is to be removed first.

In some optional implementations, the apparatus for data processing further includes a conversion unit (not shown), which is configured to: convert the bidirectional association relationship to a unidirectional association relationship based on a received conversion operation for the association relationship.

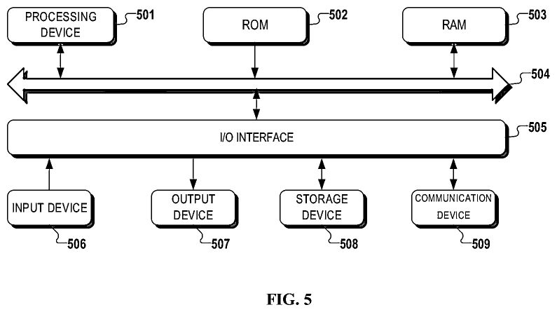

Referring to FIG. 4, which illustrates an exemplary system architecture to which a method for content presentation of an embodiments of the present disclosure may be applied.

As shown in FIG. 4, the system architecture may include end devices 401, 402, and 403, a network 404, and a server 405. The network 404 may be used to provide a medium of a communication link between the end devices 401, 402, and 403 and the server 405. The network 404 may include various connection types, such as wired, wireless communication links or fiber optic cables, among others.

The end devices 401, 402, and 403 may interact with the server 405 via the network 404 to receive or transmit messages, etc. The terminal devices 401, 402, and 403 may have various client applications installed on them, such as a web browser application, a search application, a news and information application. The client applications in the terminal devices 401, 402, and 403 may receive commands from the user and complete corresponding functions according to the user's commands, such as adding corresponding information to the message according to the user's commands.

The terminal devices 401, 402, and 403 may be hardware or software. When the terminal device 401, 402, and 403 is hardware, it may be a variety of electronic devices having a display screen and supporting web browsing, including but not limited to a smartphone, a tablet computer, an e-book reader, an MP3 player (Moving Picture Experts Group Audio Layer III, Moving Picture Experts Compression Standard Audio Layer 3), MP4 (Moving Picture Experts Group Audio Layer IV, Moving Picture Experts Compression Standard Audio Layer 4) players, laptop and desktop computers, and the like. When the terminal devices 401, 402, and 403 are software, they may be installed in the electronic devices listed above. It may be realized as a plurality of software or software modules (e.g., software or software modules used to provide distributed services) or as a single software or software module. No specific limitations are made herein.

The server 405 may be a server that provides various services, such as storing data transmitted from the terminal device 401, and transmitting the data stored in a data table to the terminal devices 401, 402, and 403.

It is to be noted that the method for data processing provided by the embodiments of the present disclosure may be implemented by a terminal device 401, 402, and 403. Accordingly, the apparatus for data processing may be disposed in the terminal device 401, 402, and 403.

It should be understood that the number of terminal devices, networks, and servers in FIG. 4 is merely illustrative. There may be any number of terminal devices, networks, and servers as needed for implementation.

Reference is made below to FIG. 5, which illustrates a schematic view of a structure of an electronic device (e.g., a terminal device in FIG. 4) suitable for use in realizing an embodiment of the present disclosure. Terminal devices in embodiments of the present disclosure may include, but are not limited to, mobile terminals such as cell phones, laptop computers, digital broadcast receivers, PDAs (personal digital assistants), PADs (tablet computers), PMPs (portable multimedia players), in-vehicle terminals (e.g., in-vehicle navigation terminals), and the like, as well as fixed terminals such as digital TVs, desktop computers, and the like. The electronic device illustrated in FIG. 5 is merely an example and should not suggest any limitation on the functions and scope of use of the embodiments of the present disclosure.

As illustrated in FIG. 5, the electronic device may include a processing device (e.g., a central processor, a graphics processor, and the like) 501 which may perform various appropriate actions and processes based on a program stored in a read-only memory (ROM) 502 or loaded from a storage device 508 into a random access memory (RAM) 503. Also stored in the RAM 503 are various programs and data necessary for the operation of the electronic device 500. The processing device 501, the ROM 502, and the RAM 503 are connected to each other via a bus 504. The input/output (I/O) interface 505 is also connected to the bus 504.

Typically, the following devices may be connected to the I/O interface 505: an input device 506 including, for example, a touch screen, a touch pad, a keyboard, a mouse, a camera, a microphone, an accelerometer, a gyroscope, and the like; an output device 505 including, for example, a liquid crystal display (LCD), a loudspeaker, a vibrator, and the like; a storage device 508 including, for example, a magnetic tape, a hard disk, and the like; and a communication device 509. The communication device 509 may allow electronic devices to wirelessly or wiredly communicate with other devices to exchange data. Although FIG. 5 illustrates an electronic device with various devices, it should be understood that it is not required to implement or have all of the illustrated devices. More or fewer devices may alternatively be implemented or possessed.

In particular, according to embodiments of the present disclosure, the processes described above with reference to the flowcharts may be implemented as computer software programs. For example, embodiments of the present disclosure include a computer program product comprising a computer program carried on a non-transitory computer-readable medium, the computer program comprising program code for performing the method shown in the flowchart. In such embodiments, the computer program may be downloaded and installed from a network via a communication device 509, or installed from a storage device 508, or installed from a ROM 502. When this computer program is executed by the processing device 501, the above-described functions defined in the method of the embodiments of the present disclosure are performed.

It is noted that the computer-readable medium described above in the present disclosure may be a computer-readable signal medium or a computer-readable storage medium or any combination thereof. The computer-readable storage medium may, for example, be—but is not limited to—a system, device, or apparatus or device of electricity, magnetism, light, electromagnetism, infrared, or semiconductors, or any combination of the above. More specific examples of computer-readable storage media may include, but are not limited to: electrical connections having one or more wires, portable computer disks, hard disks, random access memory (RAM), read-only memory (ROM), erasable programmable read-only memory (EPROM or flash memory), optical fibers, portable compact disk read-only memories (CD-ROM), optical storage devices, magnetic memory device, or any suitable combination of the foregoing. In the context of the present disclosure, a computer-readable storage medium may be any tangible medium containing or storing a program that may be used by or in combination with an instruction execution system, apparatus, or device. In the context of the present disclosure, a computer-readable signal medium may include a data signal propagated in a baseband or as part of a carrier that carries computer-readable program code. Such propagated data signals may take a variety of forms, including, but not limited to, electromagnetic signals, optical signals, or any suitable combination of the foregoing. The computer-readable signalling medium may also be any computer-readable medium other than a computer-readable storage medium, which computer-readable signalling medium may send, propagate, or transmit a program for use by, or in conjunction with, an instruction-executing system, apparatus, or device. The program code contained on the computer-readable medium may be transmitted using any suitable medium, including, but not limited to: wire, fibre optic cable, RF (radio frequency), etc., or any suitable combination of the foregoing.

In some embodiments, the client and the server may communicate by using any currently known or future developed network protocol such as HTTP (HyperText Transfer Protocol), and may be interconnected with digital data communication in any table or medium (for example, communication network). Examples of communication networks include a local area network (“LAN”), a wide area network (“WAN”), the Internet work (for example, the Internet) and end-to-end networks (for example, ad hoc end-to-end networks), as well as any currently known or future developed networks.

The computer-readable medium may be included in the electronic device, or it may exist alone without being assembled into the electronic equipment.

The computer-readable medium carries one or more programs, which, when executed by the electronic device, cause the electronic device to: obtain a first data table and a second data table; and determine an associated field in the first data table, and establishing a bidirectional association relationship between the first data table and the second data table through the associated field, wherein a target permission for using the first data table is set for a target user in the establishment of the bidirectional association relationship, the target user being a user associated with the second data table.

Computer program code for performing the operations of the present disclosure may be written in one or more programming languages, or combinations thereof, including, but not limited to, object-oriented programming languages—such as Java, Smalltalk, C++—and conventional procedural programming languages—such as the “C” language. “C” or similar programming languages. The program code may be executed entirely on the user's computer, partially on the user's computer, as a stand-alone software package, partially on the user's computer and partially on a remote computer, or entirely on a remote computer or server. In the case involving a remote computer, the remote computer may be connected to the user computer via any kind of network—including a local area network (LAN) or a wide area network (WAN)—or, alternatively, it may be connected to an external computer (e.g., by utilizing an Internet service provider to connect via the Internet).

The flowcharts and block diagrams in the accompanying drawings illustrate the architecture, functionality, and operation of systems, methods, and computer program products that may be implemented in accordance with various embodiments of the present disclosure. At this point, each box in the flowcharts or block diagrams may represent a module, program segment, or portion of code that contains one or more executable instructions for implementing a specified logical function. It should also be noted that in some implementations as replacements, the functions labeled in the boxes may also occur in a different order than those labeled in the accompanying drawings. For example, two consecutively represented boxes may actually be executed substantially in parallel, and they may sometimes be executed in reverse order, depending on the function involved. It is also noted that each of the boxes in the block diagram and/or flowchart, and combinations of the boxes in the block diagram and/or flowchart, may be implemented with a specialized hardware-based system that performs the specified function or operation, or may be implemented with a combination of specialized hardware and computer instructions.

The units described as being involved in embodiments of the present disclosure may be implemented by way of software or may be implemented by way of hardware. The name of a unit does not constitute any limitation to the unit itself.

The functions described above herein may be performed, at least in part, by one or more hardware logic components. For example, non-limitingly, exemplary types of hardware logic components that may be used include: field programmable gate arrays (FPGAs), application-specific integrated circuits (ASICs), application-specific standard products (ASSPs), systems-on-chip (SOCs), complex programmable logic devices (CPLDs), and the like.

In the context of the present disclosure, a machine-readable medium may be a tangible medium that may contain or store a program for use by or in conjunction with an instruction execution system, device, or apparatus. The machine-readable medium may be a machine-readable signal medium or a machine-readable storage medium. The machine-readable medium may include, but is not limited to, an electronic, magnetic, optical, electromagnetic, infrared, or semiconductor system, device, or apparatus, or any suitable combination of the foregoing. More specific examples of machine-readable storage media would include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination of the foregoing. any suitable combination thereof.

The foregoing descriptions are merely illustrative of the preferred embodiments of the present disclosure and of the technical principles utilized. It should be understood by those skilled in the art that the scope of the disclosure covered in the present disclosure is not limited to a technical solution formed by a particular combination of the above-described technical features, but also covers other technical solutions formed by any combination of the above-described technical features or their equivalent without departing from the above-described disclosure concept. For example, a technical solution formed by interchanging the above features with (but not limited to) technical features with similar functions disclosed in the present disclosure.

Furthermore, while the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logic actions, it should be understood that the subject matter defined in the appended claims is not necessarily limited to the particular features or actions described above. Rather, the particular features and actions described above are merely exemplary forms of implementing the claims.

1. A method for data processing, comprising:
obtaining a first data table and a second data table; and
determining an associated field in the first data table, and establishing a bidirectional association relationship between the first data table and the second data table through the associated field,
wherein a target permission for using the first data table is set for a target user in the establishment of the bidirectional association relationship, the target user being a user associated with the second data table.

2. The method of claim 1, wherein the target permission comprises one of the following:
the first data table being invisible, the first data table being visible but non-editable, the associated field being non-editable, a target row being invisible, the target row is visible but non-editable, a target column being invisible, or the target column being visible but non-editable.

3. The method of claim 1, wherein the target permission for using the first data table is set for a target user in the establishment of the bidirectional association relationship comprises:
in response to the establishment of the bidirectional association relationship being trigged by the user, displaying a permission setting item; and
determining the target permission based on a selection operation of the user for the permission setting item.

4. The method of claim 1, wherein the method further comprises: creating a matching field corresponding to the associated field in the second data table.

5. The method of claim 4, wherein an identification of the matching field comprises at least a part of an identification of the associated field.

6. The method of claim 1, wherein the method further comprises:
in response to that a view of the first data table is not locked, displaying a data view of the second data table based on a trigger operation of the user for the associated field.

7. The method of claim 6, wherein displaying the data view of the second data table comprises:
in response to that the view of the first data table is not locked, displaying complete table data of the second data table.

8. The method of claim 6, wherein displaying the data view of the second data table comprises:
in response to that the view of the first data table is not locked, displaying a chart corresponding to data in the second data table based on a selection of the user.

9. The method of claim 1, wherein the method further comprises:
in response to updating of data corresponding to the associated field in the first data table, updating synchronously in the second data table; or
in response to updating of data corresponding to a matching field in the second data table, updating synchronously in the first data table.

10. The method of claim 1, wherein the method further comprises:
setting a range of records of the second data table bidirectionally associated with the first data table in a state where the associated field is selected.

11. The method of claim 10, wherein the setting a range of records of the second data table bidirectionally associated with the first data table in a state where the associated field is selected comprises:
in response to a presetting operation of the user for the associated field, displaying a filtering criteria entry; and
determining the range of records of the associated field that is bidirectionally associated with the second data table based on a filtering criteria set by the user at the filtering criteria entry.

12. The method of claim 1, wherein determining an associated field in the first data table, and establishing a bidirectional association relationship between the first data table and the second data table through the associated field comprises:
selecting, in the second data table, at least two records that are bidirectionally associated with the associated field in the first data table.

13. The method of claim 12, wherein the method further comprises:
maintaining, based on a change operation performed by the user that changes a multi-record association to a single record association, a multi-record association established before the change operation, and
after the change operation, bidirectionally associating, based on a selection operation of the user for the single record, the selected single record and the associated field.

14. The method of claim 1, wherein the method further comprises:
searching for at least one record in the first data table or the second data table by means of fuzzy query.

15. The method of claim 14, wherein searching for at least one record by means of fuzzy query comprises:
searching for a record matching each of at least one keyword based on the at least one keyword inputted by means of fuzzy query.

16. The method of claim 1, wherein the associated field corresponds to the matching field, and the method further comprises:
in response to receiving an instruction for deleting the associated field, displaying first delete indication information, the first delete indication information being used to indicate that the associated field is associated with the matching field, and indicate that the association relationship therebetween is to be removed first; or
in response to receiving an instruction for deleting the matching field, displaying a second delete indication message, the second delete indication message being used to indicate that the matching field is associated with the associated field, and indicate remove the association relationship therebetween is to be removed first.

17. The method of claim 1, wherein the method further comprises:
converting the bidirectional association relationship to a unidirectional association relationship based on a received conversion operation for the association relationship.

18. An electronic device, comprising:
one or more processors; and
a storage device for storing one or more programs,
the one or more programs, when executed by one or more processors, cause the one or more processors to implement a method for data processing comprising:
obtaining a first data table and a second data table; and
determining an associated field in the first data table, and establishing a bidirectional association relationship between the first data table and the second data table through the associated field,
wherein a target permission for using the first data table is set for a target user in the establishment of the bidirectional association relationship, the target user being a user associated with the second data table.

19. The electronic device of claim 1, wherein the target permission comprises one of the following:
the first data table being invisible, the first data table being visible but non-editable, the associated field being non-editable, a target row being invisible, the target row is visible but non-editable, a target column being invisible, or the target column being visible but non-editable.

20. A non-transitory computer readable storage medium having computer-executable instructions stored thereon which, when executed by a processor, implementing a method for data processing comprising:
obtaining a first data table and a second data table; and
determining an associated field in the first data table, and establishing a bidirectional association relationship between the first data table and the second data table through the associated field,
wherein a target permission for using the first data table is set for a target user in the establishment of the bidirectional association relationship, the target user being a user associated with the second data table.
